(19) United States
(12) Patent Application Publication
(10) Pub. No.: US 2010/0039487 A1
(43) Pub. Date: Feb. 18, 2010

(54) Digital Ink Jet Printer and Process

(76) Inventor: Hank Sawatsky, Wiarton (CA)

Correspondence Address: SoCAL IP LAW GROUP LLP, 310 N. WESTLAKE BLVD. STE 120, WESTLAKE VILLAGE, CA, 91362, US

(21) Appl. No.: 12/192,013

(22) Filed: Aug. 14, 2008

(51) Int. Cl. B41J 2/01

(52) U.S. Cl. 347/102

(57) ABSTRACT

There is provided a digital ink jet printer for printing and curing graphics on a cylindrical object comprising: (i) a printhead assembly comprising at least one printhead, wherein said at least one printhead contains ink; ii) a UV lamp for curing ink, attached to the printhead assembly, wherein said UV lamp is aligned in a plane with said at least one printhead; and (iii) a carrier moveably attached to said printhead assembly, wherein said carrier is positioned such that the cylindrical object is below the printhead assembly.

### FIELD OF THE INVENTION

The invention relates to digital ink jet printers for printing graphics on cylindrical objects.

### BACKGROUND OF THE INVENTION

The US promotional products industry generated over $18 billion in 2005 and continues to grow at a significant rate. However, current technology for decorating cylindrical promotional products includes much inefficiency. The predominant method of decorating products is by screen printing which has many associated problems. Preparing artwork requires separation of colours, manual colour matching, making screens, transferring the artwork onto the screens, and tedious set-up procedures to register the colours during printing. Screen printing also has its limitations in that it is incapable of printing process colours. The inks for glass and ceramics are severely limited by the Food and Drug Administration as there is concern regarding the carcinogenic properties of some of the ceramic inks. Furthermore, the cost of these various procedures tends to severely distort the selling price of the product that is being decorated. There is a need to eliminate the high energy used in curing the ink, for a much more productive method of decorating and for higher quality graphics.

### SUMMARY OF THE INVENTION

Two new processes using digital graphics have been introduced recently to meet the needs discussed above. One process consists of digital offset printing on a film, wrapping the film around the product to be decorated, applying heat and pressure which transfers the ink to the product. The second process ink jet prints on a clear pressure sensitive film which is then cut to size and is applied, like a label, to the product for decoration. The digital ink jet printing process and the digital ink jet printer of the present invention greatly simplify the decorating process, reducing cost as it is printing directly onto the cylindrical product, and achieving superior quality graphics. The inks used are all organic, thereby eliminating health and environmental concerns.

The present invention provides a digital ink jet printing system for printing directly onto cylindrical objects. The printing system includes a printhead for printing ink onto a cylindrical item that is supported on a carrier wherein the carrier is movable relative to the printhead.

According to one aspect of the present invention there is provided a digital ink jet printer for printing directly onto a cylindrical object comprising: a printhead assembly including at least two printheads including ink operatively connected to said digital ink jet printer, one of the printheads being adapted to print white ink onto said object; a carrier for supporting the object; positioning means for sequentially positioning the carrier relative to the printhead assembly for printing ink onto the object; a controller connected to the positioning means and to the printer for providing instructions for printing a pre-determined print pattern on the object and for sequentially moving the positioning means.

According to another aspect of the present invention there is provided a digital ink jet printer for printing and curing graphics directly onto on a cylindrical object comprising: (i) a printhead assembly comprising at least one printhead, wherein said at least one printhead contains ink; ii) a UV lamp for curing ink, attached to the printhead assembly, wherein said UV lamp is aligned in a plane with said at least one printhead; and (iii) a carrier moveably attached to said printhead assembly, wherein said carrier is positioned such that the cylindrical object is below the printhead assembly.

According to another aspect of the present invention there is provided a method of printing and curing graphics directly onto on a cylindrical object using the digital ink jet printer comprising: (i) a printhead assembly comprising at least one printhead, wherein said at least one printhead contains ink; ii) a UV lamp for curing ink, attached to the printhead assembly, wherein said UV lamp is aligned in a plane with said at least one printhead; and (iii) a carrier moveably attached to said printhead assembly, wherein said carrier is positioned such that the cylindrical object is below the printhead assembly, comprising the steps of: placing the cylindrical object in the carrier; moving the carrier under the at least one printhead; firing the ink in the at least one printhead onto the cylindrical object; moving the carrier under the UV lamp; curing the ink on the cylindrical object with the UV lamp.

### BRIEF DESCRIPTION OF THE DRAWINGS

In drawings which illustrate by way of example only a preferred embodiment of the invention,

FIG. 1 is a perspective view of a preferred embodiment of the present invention in a first operating position

FIG. 2 is a perspective view of a preferred embodiment of the present invention in a second operating position;

FIG. 3 is a perspective view of a preferred embodiment of the present invention in a third operating position;

FIG. 4 is a front view of an alternate embodiment of the present invention; and

FIG. 5 is a side view of an alternate embodiment of the present invention;

### DETAILED DESCRIPTION OF THE INVENTION

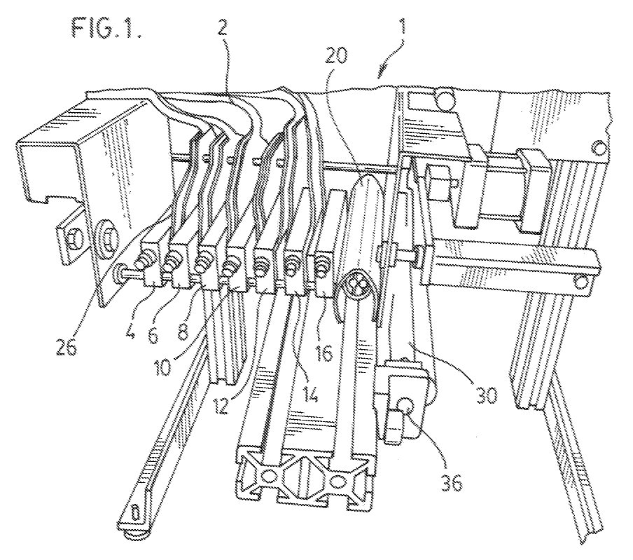

As shown in the figures, digital ink printer system 1 includes a printhead assembly 2. The printhead assembly 2 has a printhead and preferably at least two printheads. Preferably, the printheads are the Xaar 318s for pens. There are other printhead designs for products such as glass tumblers or ceramic mugs. The printheads are preferably at least 50 mm wide. In the preferred embodiment shown in FIGS. 1 to 3, the printhead assembly operates as a shuttle and has seven printheads, namely first printhead 4, second printhead 6, third printhead 8, fourth printhead 10, fifth printhead 12, sixth printhead 14 and seventh printhead 16. Each of the printheads receives ink from an ink container 26.

In the preferred embodiment each of the printheads contains ink of a different colour. These colours include at least white, cyan, magenta, yellow and black. Preferably the ink is HexiLok™ ink for glass and ceramics and metals. Other Hexion specialized inks are used on various other applications, such as pens.

A UV lamp 20 is attached to the printhead assembly. The UV lamp 20 is aligned in a plane with said at least one of the printheads. In the preferred embodiment, the printheads and the UV lamp are all aligned on the same plane.

A cylindrical object 30 is received in a chuck 28 of a carrier 36. The carrier 36 is moveably attached to the printhead assembly 2. The carrier 36 is positioned such that the cylindrical object 30 is below the printhead assembly 2. Preferably, the carrier 36 is capable of rotating the cylindrical object 30. The carrier is adapted to move along an axis of movement along a plane that is parallel to the plane of the printheads. This is preferably accomplished by positioning means for sequentially positioning the carrier relative to the printhead assembly for printing ink onto said items. The rotation and positioning means is preferably in the form of a stepper motor 58 that is connected to either the carrier, the printhead assembly or both. The stepper motor is triggered by a sensor which gauges the diameter or the height of the object to be printed and moves the shuttle in a vertical direction so there is always a 1 mm clearance between the printhead and the object to be printed.

The cylindrical object 30 is preferably a promotional item and most preferably a pen. However the digital ink printer system 1 can be used to print on any type of cylindrical object.

The printhead assembly can be attached to a moveable shuttle, and the direction of the moveable shuttle can be perpendicular to an axis of movement of the carrier. Printheads are preferably spaced exactly 1½″ apart and are removable for maintenance.

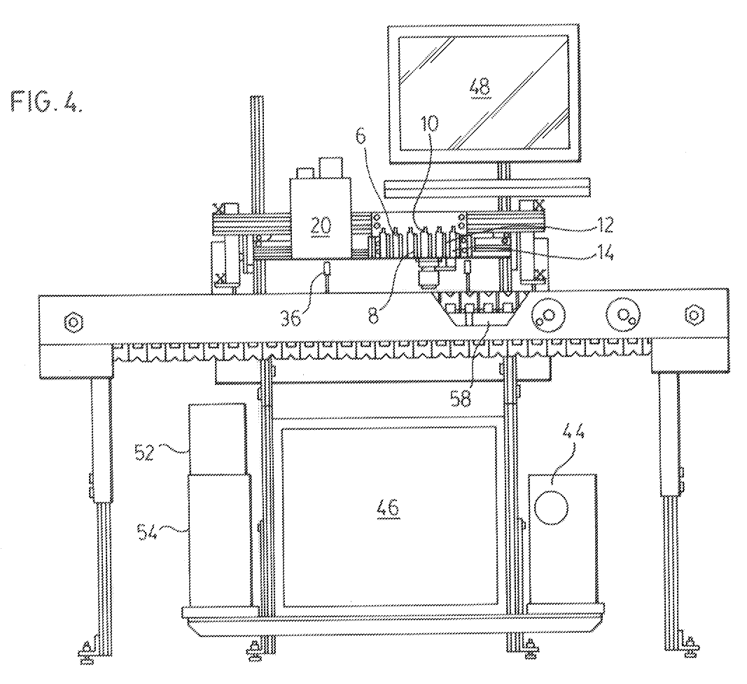

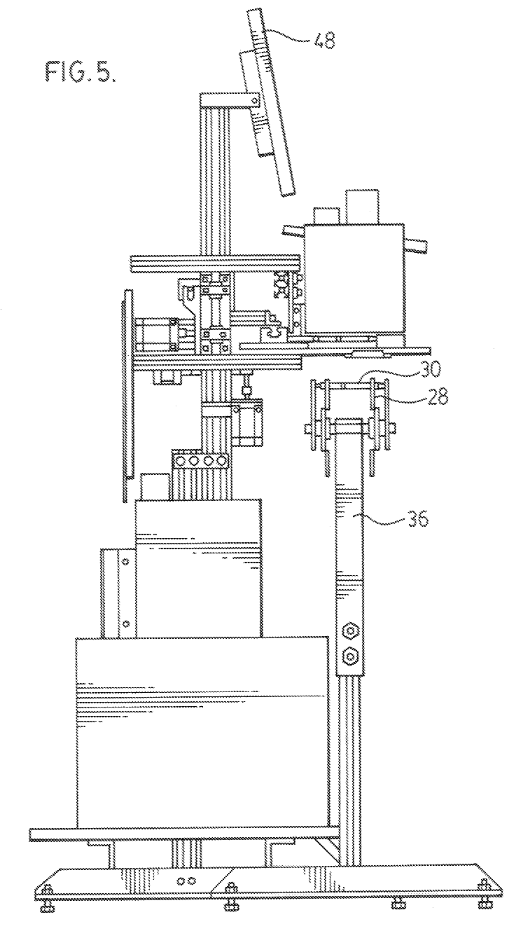

A controller is connected to the positioning means and to the printhead assembly 2 for providing instructions for printing a pre-determined print pattern on said items and for sequentially moving the positioning means. The controller is preferably a computer 44, as shown in FIGS. 4 and 5. The computer 44 has a motion control panel 46 and a display screen 48. As shown in FIGS. 4 and 5, the digital ink printer 1 includes a UV power supply 54 and a UV blower 52.

The system includes stepper motors (not shown) that rotate the pen and move the carrier 36 in four horizontal directions. The system also includes a final UV curing unit (not shown).

In the preferred embodiment the cylindrical objects are pens. In operation, the pens 30 are fed one at a time on the carrier 36. As the pen 30 approaches a printhead, a mechanism on the carrier raises the pen where it is grasped by the chuck 28 and placed next to the printheads. FIG. 1 shows the pen in the ‘load’ and ‘unload’ position. The printheads and UV Lamp remain in a fixed position during printing and the pen travels horizontally below them.

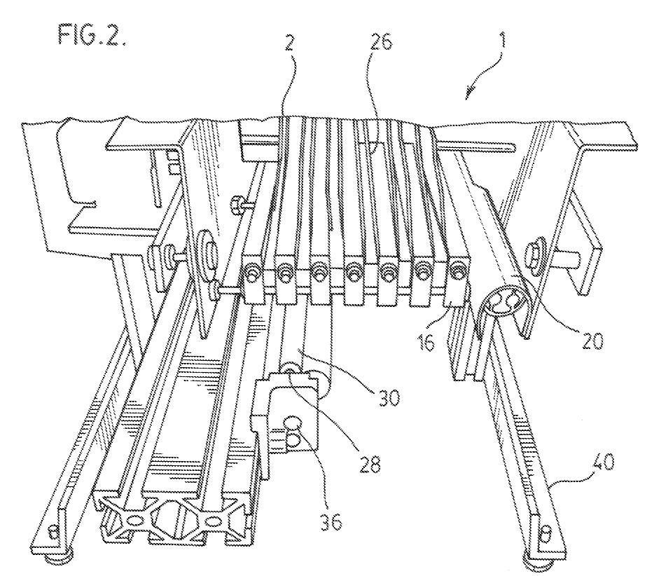

The pen 30, which is held by a chuck or mandrel 28, moves under printhead 6, as shown in FIG. 2. Printhead 4 is not used for pen printing in the preferred embodiment. As the pen 30 comes to a stop under printhead 6, preferably white ink is “fired” onto the rotating pen as required in the graphics. The pen then immediately moves to printheads 8, 10, 12 and 14, stopping momentarily under each printhead where cyan, magenta, yellow and black respectively are fired. At that point the entire graphics have been applied.

It is preferred that printing begins with white ink, even when the product being decorated is white. Digital ink jet inks are formulated to have the same surface tension so that they exactly lie in the same dot pattern each time (ink is jetted in small dots and they're applied between the dots of the previously applied colors). Unlike the cyan, magenta, yellow and black colors, white ink is jetted in larger dots which spread and flow into each other forming an almost continuous and opaque surface (blocking out light transmission) as the cyan, magenta, yellow and black colors are quite transparent. With a constant white background the cyan, magenta, yellow and black colors applied overtop produce the preplanned graphic effects and the desired color match.

In advance of the printing step, set up information is programmed into the computer regarding the specifications of the pen (i.e. barrel diameter and extension of the pen clip). On the first cycle of a new print job, after the pen is placed in to the chuck and mandrel, the printhead assembly is positioned by a lead-screw, driven by a stepper motor, so that a set of limit sensors are exposed to the pen barrel by lowering the assembly until a signal is received from the barrel sensor. Also, the pen clip is positioned so that the printhead assembly can sense the proper distance. Those distances are then recorded into the software and from there calculated to precisely position the printheads.

The printing step at each printhead is carried out with the pen barrel rotating in one direction as part of the image is deposited. Upon completion of a first ink deposit, the pen reverses back to the start of the image while the printhead is moved one pixel over. Due to the native nozzle spacing, the pen rotates forward to complete a first image of a first color. The first image is preferably the white. Furthermore, the first print is sometimes partially cured by a UV light, to assure the rest of the colors have a solid base. The rest of the image is printed according to the same procedure at the other printheads. Upon completion of the printing the pen is again placed under the UV light to completely cure the colors. The pen is then released into a pen lift mechanism, and lowered into the chain conveyor, which moves over one position to pick-up the next pen to be printed. The chain conveyor is extended so that products printed with HexiLok ink will enter an InfraRed or conventional curing oven to fully cure the ink.

Glass, ceramic and metal products preferably are printed with the specially formulated HexiLok inks for adhesion and toughness and consist of two components. One of the components is UV cured as described above, the second component is cured by InfraRed or conventional heat in a conveyorized oven.

The machine mechanics function as follows: as the pen is located under a printhead, a small stepper motor rotates the pen chuck/mandrel assembly forward and backwards at the precise positions to not let the pen clip touch the printhead nozzle surface. Also during this action the step or position of the pen is fed back to the printing software for it to fire the nozzle at the right time. While the pen barrel shuttles forwards the first print is applied. As the pen reverses, the printhead assembly is moved over one pixel by a stepper motor with a canterlever cam. This cam has the capability to reposition the printhead assembly with accuracy of ±0.00025 inches, but also move the whole assembly 2″ over to allow a full 4″ wide (or high) print on the pen barrel. The printhead assembly is mounted on a linear zero clearance glider assembly (THK), and driven by a micro step controlled stepper motor to position the proper printhead over the pen in the exact location. Also this information is fed back to the printhead software to let it know what color to print. For color registration the printer can use the clip of the pen as reference or it can use the first print of the graphics. The basic graphics print quality of the DIJ Printer described herein is 300-360 dpi (dots per square inch), the usual magazine quality. The Xaar printheads make the DIJ printer capable of six or eight grey scales, up to a dpi range of 900-1200 which is described as ‘near photo’ quality.

The preferred ink for carrying out the present invention is HexiLok™ ink developed by Hexion Specialty Chemicals Inc., Cincinnati, Ohio. It has been found that HexiLok™ has exceptional adhesion qualities required for glass, ceramics and metal and eliminates both the silicone and the polyurethane, thereby reducing cost and shortening the printing process. DIJ Inks are drawn from ink bottles and pumped to the printheads by a specialized ink delivery system (not shown) which operates under negative pressure to eliminate bubbles in the printheads which would cause misprints.

HexiLok™ and other Hexion inks are available in white, cyan, magenta, yellow and black and are usually jetted in that sequence but the sequence will sometimes change for certain graphic effects. White is preferably used to create a sound and adhering base followed by the cyan, magenta, yellow and black colors. The cyan, magenta, yellow and black inks are adjusted to the same surface tension as the white ink.

HexiLok inks have two major components, one is cured by UV and the other component requires curing by either infrared or conventional heat.

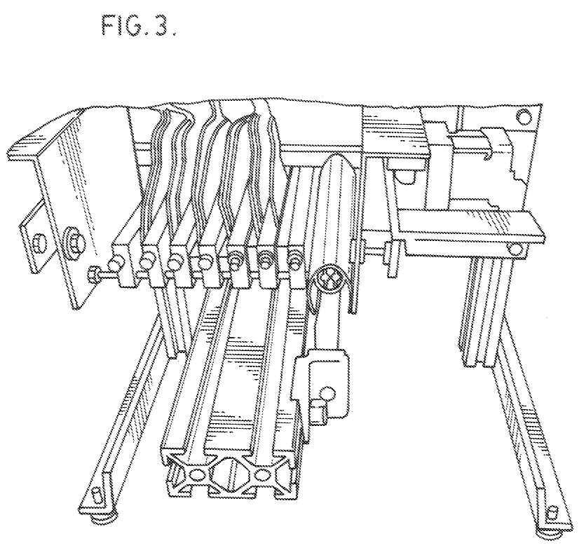

As shown in FIG. 3, the pen 30 moves under the UV lamp 20 where the graphics sometimes are partially cured to prevent the ink droplets from spreading and assuring that the resolution of print remains unchanged. The pen 30 with complete five color graphics is then picked from the printer by a conveyor and taken down the line for packaging to a UV curing tunnel. Total time of the printing and UV curing for the finished product is preferably approximately 4.8 seconds.

Two computers are used in the graphics and order preparation and graphics printing. Artwork, color matching order details, model of pen, positioning of the graphics, etc. are entered in a first computer which sends the information to a PLC computer which drives the printhead assembly.

The digital ink printer system includes sensors for detecting the diameter of the pen so that the system automatically positions the printheads to the correct height with 1 mm clearance. If graphics are to be printed on the clip of the pen, the digital ink printer system senses the height and the printheads are automatically raised to the correct height.

The printheads and UV lamp are part of a shuttle which can be positioned forward and back to print the graphics in the desired location on the pen. Graphics can be printed completely around the pen. If the pen has a clip attached the pen rotation and printing stop short of the clip and is UV cured as it rotates in the opposite direction and is ready for the next color to be applied.

The digital ink jet printer of the present invention has many capabilities. These include the ability to printing a 180° arc on a pen around a pen clip; printing on the pen clip; printing a 360° deg full wrap below the pen clip; printing a 4″ full wrap on a pen with no clip; almost continuous printing where the computer counts the number of prints, pauses a few seconds at order completion, then begins a new order with different graphics. All functions are programmed into the system, are triggered by entering the graphics artwork and are automatically printed.

The present invention provides a printer that operates with complete automation. In the case of pens, they can be hand fed, or automatically located onto the printer's conveyor, then are picked off the conveyor, placed into the printer, printed, cured, deposited back on the conveyor and dropped into a shipping carton. Glass, ceramics and metal can be hand loaded and unloaded but ideally robots take the units from the shipping cartons, place them in the printer and later place them back in the shipping carton.

In an alternate embodiment of the invention, the printer is designed to print two products at the same time, thereby doubling the output.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A digital ink jet printer for printing directly onto a cylindrical object, comprising:
a printhead assembly including at least two printheads including ink operatively connected to said digital ink jet printer, one of the printheads being adapted to print white ink onto said object;
a carrier for supporting the objects;
positioning means for sequentially positioning the carrier relative to the printhead assembly for printing ink onto said object;
a controller connected to the positioning means and to the printer for providing instructions for printing a pre-determined print pattern on said object and for sequentially moving said positioning means.

2. A digital ink jet printer according to claim 1, further comprising a UV lamp for curing ink, attached to the printhead assembly, wherein said UV lamp is aligned in a plane with said at least one printhead.

3. A digital ink jet printer according to claim 1, wherein the printer head assembly includes a plurality of printer heads, each printer head being adapted to print a different colour.

4. A digital ink jet printer according to claim 3, wherein the colours printed by the printer heads include white, cyan, magenta, yellow and black.

5. The digital ink jet printer of claim 4, wherein the ink is HexiLok™ ink.

6. The digital ink jet printer of claim 1, wherein a computer is programmed to position the at least one printhead to a pre-determined distance above the carrier.

7. The digital ink jet printer of claim 1, wherein the printhead assembly is attached to a moveable shuttle, and wherein the direction of the moveable shuttle is perpendicular to the axis of movement of the carrier.

8. The digital ink jet printer of claim 1, wherein the carrier is capable of rotating the cylindrical object.

9. A digital ink jet printer for printing and curing graphics directly onto on a cylindrical object, comprising:
(i) a printhead assembly comprising at least one printhead, wherein said at least one printhead contains ink;
(ii) a UV lamp for curing ink, attached to the printhead assembly, wherein said UV lamp is aligned in a plane with said at least one printhead; and
(iii) a carrier moveably attached to said printhead assembly, wherein said carrier is positioned such that the cylindrical object is below the printhead assembly.

10. The digital ink jet printer of claim 9, wherein the UV lamp and the at least one printhead are aligned parallel to each other.

11. The digital ink jet printer of claim 9, wherein the printhead assembly comprises a plurality of printheads.

12. The digital ink jet printer of claim 11, wherein the printhead assembly comprises four printheads, and wherein the four printheads contain cyan, magenta, yellow and black ink, respectively.

13. The digital ink jet printer of claim 11, wherein the printhead assembly comprises five printheads, and wherein the five printheads contain white, cyan, magenta, yellow and black ink, respectively.

14. The digital ink jet printer of claim 13, wherein the ink is HexiLok™ ink.

15. The digital ink jet printer of claim 9, wherein a computer is programmed to position the at least one printhead to a pre-determined distance above the carrier.

16. The digital ink jet printer of claim 9, wherein the printhead assembly is attached to a moveable shuttle, and wherein the direction of the moveable shuttle is perpendicular to the axis of movement of the carrier.

17. The digital ink jet printer of claim 9, wherein the carrier is capable of rotating the cylindrical object.

18. A method of printing and curing graphics on a cylindrical object using the digital ink jet printer of claim 11, comprising:
(i) placing the cylindrical object in the carrier;
(ii) moving the carrier under the at least one printhead;
(iii) firing the ink in the at least one printhead onto the cylindrical object;
(iv) moving the carrier under the UV lamp; and
(v) curing the ink on the cylindrical object with the UV lamp.

19. The method of claim 18, wherein the carrier moves under each of the plurality of printheads.

20. The method of claim 18, wherein the carrier first moves under the printhead containing white ink.

21. The method of claim 18, further including the step of curing the cylindrical object with infrared light or conventional heat.
